(19) United States
(12) Patent Application Publication
(10) Pub. No.: US 2012/0233014 A1
(43) Pub. Date: Sep. 13, 2012

(54) METHOD AND SYSTEM FOR ONLINE ASSISTED SALES OF A MOTOR VEHICLE

(76) Inventors: David D. Banks, Richmond, VA (US); Gregory Neel Shull, Richmond, VA (US); Richard M. Smith, Midlothian, VA (US); Robert Lee McLemore, Richmond, VA (US)

(21) Appl. No.: 13/043,765

(22) Filed: Mar. 9, 2011

(51) Int. Cl. G06Q 30/00

(52) U.S. Cl. 705/26.7; 705/27.1

(57) ABSTRACT

The present invention provides a method and system for an online automotive purchase including receiving a user input for determining and verifying an identity of a user engaging in an online purchase. It includes determining a plurality of characteristics of the user usable for the online purchase and in response to at least one user selection command, determining at least one automobile available for purchase by the user. It includes receiving a plurality of financial information associated with the user for securing the automobile via the online purchase and determining financial terms for the online automotive purchase based on the financial information associated with the user. It further includes presenting the financial terms to the user across and performing a plurality of settlement transactions for fulfillment of the online automotive transaction, as well as notifying the user of the availability for delivery of the automobile.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present invention relates generally to the shopping and purchase of a motor vehicle and more specifically to utilizing online systems and methods for facilitating the purchase of a motor vehicle.

### BACKGROUND OF THE INVENTION

There presently exists disconnects between physical transaction economies and the corresponding Internet-based transactions for various markets, including automotive markets. Physical transaction economies suffer from the disengagement of the customers completing a transaction via the Internet. Instead, these physical transactions rely on the physical engagements with the customer.

A classic example of a physical transaction is the purchase of a vehicle. Currently, users access the Internet as an information resource for conducting research on vehicles, including pricing and comparison information. Interactivity has evolved in this market to further include electronic inquiries using automated systems that allow users to submit his or her contact information and then a person at a corresponding dealership contacts the user to attempt to solicit a sale.

A common transaction is where the user accesses informational websites to conduct various amounts of research and then uses that research in the physical car buying transaction. Other uses include inventory searching and pricing searches. But to conduct a transaction, the user still physically travels to various car dealerships and conducts the full transaction in person.

One niche market that has seen online transactions is in specialty vehicles or car auctions. For example, users can place vehicles for sale via one or more auction websites where users can place bids for purchasing the vehicle. These auction websites, though, restrict the transaction to the pricing side of the transaction and do not facilitate any details for closing the vehicle sale. Rather, all the sale transaction aspects, but for the determination of the sale price, are done by physical transactions, whether it be via in-person or the seller preparing and submitting various paperwork to the buyer. Regardless, these auction systems utilize the Internet solely for price determination.

As such, the existing techniques for the sale of motor vehicles using the Internet are limited to vehicle research, price auctions and perfunctory general finance application advertisements. The purchase of a motor vehicle is a commercial transaction that is not currently available on the Internet because of existing limitations of physicality and a failure for any available processing system to perform the settlement beyond the mere pricing side of the transaction, including failure to provide vehicle transfer or delivery. As such, there exists a need for a system and method for purchasing and completing the sales transaction relating to a motor vehicle using the Internet for the sale and completion process, including the searching, purchase, financing, transactional upgrades, financial settlement and possible delivery.

### SUMMARY OF THE INVENTION

The present invention provides a computerized method and system for an online automotive purchase. The method and system includes receiving a user input across a computer communication network for determining and verifying an identity of a user engaging in an online purchase of an automobile and determining a plurality of characteristics of the user usable for the online purchase. The method and system includes, in response to at least one user selection command, determining, using the first processing device, at least one automobile available for purchase by the user and electronically receiving a plurality of financial information associated with the user for securing the automobile via the online purchase. The method and system additionally includes determining financial terms for the online automotive purchase based on the financial information associated with the user, including a vehicle price calculation that includes a calculation of actual taxes and fees associated with the specific vehicle and the specific sale location, presenting the financial terms to the user across the computer communication network, and upon user acceptance of the financial terms, electronically performing a plurality of settlement transactions for fulfillment of the online automotive transaction. The method and system includes notifying the user of the availability for delivery of the automobile.

Additional embodiments include vehicle delivery for the individual. This delivery may be to the individual's place of choosing, e.g. home, work, etc. or may be at a designated location, such as a car dealership by way of example. Additional embodiment include additional transaction offerings concurrent with the vehicle sale, including for example one or more extended service plans, insurance, aftermarket product upgrades, etc.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of one embodiment of the online assisted sale system;

FIG. 2 illustrates a block diagram of one embodiment of the online assisted sale system;

FIG. 3 illustrates one embodiment of a data flow diagram illustrating one embodiment of the methodology of the online assisted sales system;

FIG. 4 illustrates a flowchart of the steps of one embodiment of a method for an online assisted sales system;

FIG. 5 illustrates one embodiment of a computing architecture for the online assisted sales system;

FIG. 6 illustrates one embodiment of an active directory computing architecture within the online assisted sales system;

FIG. 7 illustrates another embodiment of a network computing architecture for the online assisted sales system;

FIG. 8 illustrates a sample screenshot of an automobile selection for an online assisted sales system;

FIG. 9 illustrates a sample screenshot of an automobile data sheet as part of the online assisted sales system;

FIG. 10 illustrates a sample screenshot of a personal information data entry page as part of the online assisted sales system;

FIG. 11 illustrates a sample screenshot of an automobile financing selection page as part of the online assisted sales system; and

FIG. 12 illustrates a sample screenshot of a settlement interface page as part of the online assisted sales system.

### DETAILED DESCRIPTION

In the following description, reference is made to the accompanying drawings that form a part hereof, and in which is shown by way of illustration specific embodiments in which the invention may be practiced. It is to be understood that other embodiments may be utilized and design changes may be made without departing from the scope of the present invention.

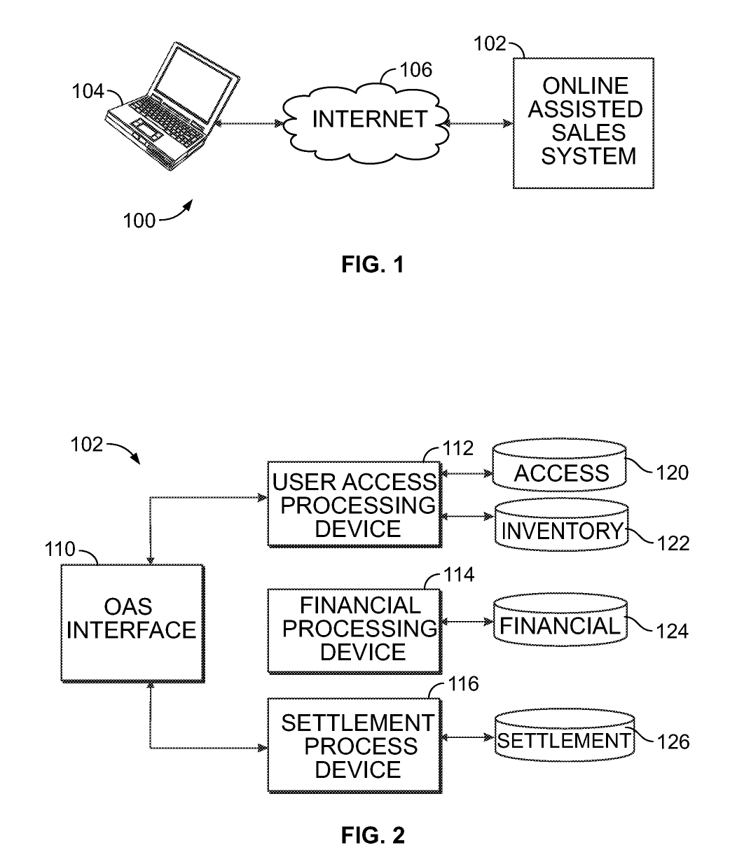

FIG. 1 illustrates a processing environment 100 having the online assisted sales system 102. In this environment, a user 104 accesses the system 102 via a networked connection 106, such as by way of example the Internet.

As described in further detail below, the online assisted sales (OAS) system 102 includes various processing operations, algorithms and routines executed in a computer processing environment. The processing environment may include one or more computing devices executing executable code from computer readable media and communication across external and/or internal network communications in a networked computing environment. Through interface functionality, as well as data access and processing operations, the online assisted sales system 102 allows the user 104 to conduct interactive operations via the network connection 106 for the searching and purchasing of an automobile.

The user 104 represents any suitable user able to access the OAS 102 via a networked connection. The user 104 may use a laptop or other mobile computer, desktop computer or any other suitable processing device, including but not limited to mobile telephones, mobile computing devices such as tablet computers, smartphones, etc. This processing device is operative to communicate across a networked connection for any available location, such as for example in the privacy of the user's home, or in another embodiment may be inside a retail store, or any other suitable location. Further details, including operational details, of the system 100 are described below.

FIG. 2 illustrates a block diagram of one embodiment of a generalized computing architecture of the OAS system 102. The system 102 includes an OAS interface 110, a user access processing device 112, a financial processing device 114 and a settlement processing device 116. Additionally, the system 102 includes a user access database 120, a vehicle inventory database 122, a financial database 124 and a settlement database 126.

FIG. 2 illustrates a generalized illustration of the system 102, where it is understood by one skilled in the art that various elements supplementing operations have been omitted for clarity purposes only. The interface 110, as well as processing devices 112, 114 and 116 may be one or more processing devices operative to perform processing operations in response to executable instructions. Those instructions may be stored on one or more computer readable medium such that upon reading the instructions, the elements of the system 102 are operative to perform the associated processing operations for performing an online sales transaction.

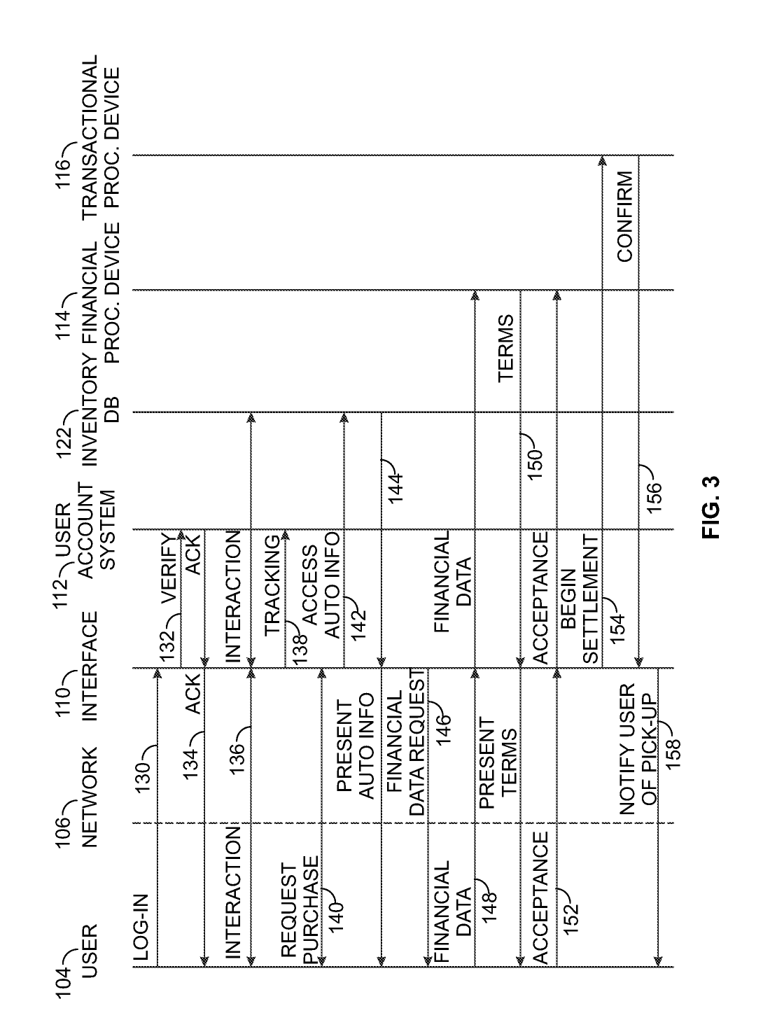

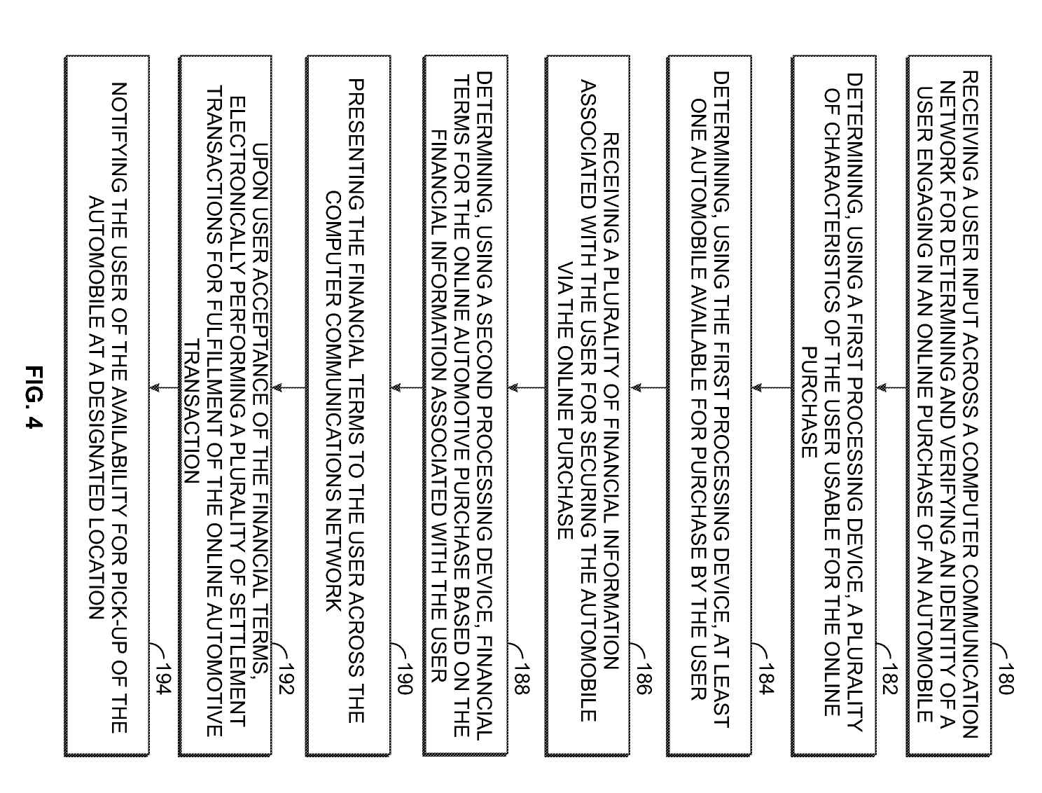

It is further recognized that the interface 110, processing devices 112, 114 and 116, as well as databases 120, 122, 124 and 126 may be disposed in one or more locations for communication across any number of available communication networks using known communication techniques. These communications may include security protocols as well as system redundancies in accordance with techniques recognized by one skilled in the art. For the sake of brevity, operations of one embodiment of the system 102 are described relative to the data flow diagram of FIG. 3, as well as the flowchart of FIG. 4.

FIG. 3 illustrates a dataflow diagram, swim lane diagram, illustrating the flow of operational steps between multiple processing components. The data flow illustrated, in this embodiment, is between the user 104, the network 106, the interface 110, a user accessing processing device 112, inventory database 122, financial system processing device 114 and the settlement processing device 116.

In one embodiment, the data flow operations include the interface 110 receiving a log-in command 130 from the user 104. The log-in command can be any suitable log-in, including for example a user-specified account with a username and password. The user 104 may establish the user account or in accordance known techniques, a new user may generate a user account prior to the log-in by filling out account information and being assigned an electronic account on the user account system 112.

Upon receipt of the log-in, the interface 110 verifies the log-in against the user account system 112. While not expressly illustrated, this may include accessing the access database 120 of FIG. 2. When the log-in is verified, an acknowledgement signal 134 is sent back to the user 104. With respect to FIG. 1, this acknowledge signal may be sent across the network 106 using any known transmission technique, including associated communication protocols, as well as security protocols to protect the integrity of the communication and data transmitted therebetween. It is recognized that in one embodiment, the user may not need to log-in to perform various of the herein described operations, including by way of example, performing vehicle searching operations.

The user 104 therein uses the interface 110 for vehicle searching interactions 136. This can include known interactions, such as performing a vehicle search by entering vehicle information and the processing device 112 accessing the inventory database 122. By way of example, the user may conduct a search for an Acura® car by typing the terms “Acura” and a particular model into a search toolbar. It is recognized that other searching techniques can be used, such as but not limited to searching by vehicle type, using a vehicle recommendation engine, searching by cost parameters or factors, etc.

Concurrent with the interactions 136, the interface 110 may be tracking the user interactions and recording that information in the user account system 112. This tracking data may be used for any number of available techniques, including but not limited to data mining relating to automotive purchasing operations or another example may be using a vehicle recommendation engine concurrent with the user searching activities. It is further noted that the user account stored in the user account system is usable for additional account-specific activities by the users, such as allowing users to save prior or current vehicle searches, set-up notifications when specific vehicles become available for sale and/or have a centralized account for storing, recording and maintaining all useful user account information.

When the vehicle has been selected, the interface 110 receives a purchase request 140 for the user 104. The interface 110 accesses the auto information 142 from the inventory database 122 and presents the automobile information 144 to the user 104 via the interface 110. It is recognized that the auto information 144 may be presented to the user, but the auto information may include additional information or a reformatted version of the automobile information during the interaction 136. In one embodiment, the request to purchase 140 may trigger additional features in the processing system, such as changing the availability status of the vehicle in the inventory database 122 and initiate vehicle sale transaction and settlement processing routines, as described in further detail below. The user also receives a vehicle specific price calculation that includes a calculation of actual taxes and fees associated with the specific vehicle at a specific sale location. As noted herein, changing the availability status may include placing a “hold” or other type of identification on the vehicle not only through the online database system, but also relative to physical relation locations so that having an interested purchaser, the vehicle becomes unavailable for purchase by another person.

The auto information 144 may include all available information relating to the automobile, including pictures, VIN, technical specifications, mileage, safety ratings, automobile features, title and maintenance history and other vehicle information. After the presentation of the automobile information 144, the interface 110 therein provides the user 104 with financial data request 146. The financial data request 146 may be a template or other type of user-interactive interface for the user entering personal information. As the financial data request 146 seeks confidential personal information, the interface 110 utilizes security or other types of data encryption to provide a secure interface to prevent the intercept or misuse of the personal data.

The interface 110 therein receives the financial data 148 from the user 104 and provides this data to the financial system 114. The interface maintains data encryption or other types of security for the safe transmission of the financial data 148 from the interface 110 to the financial system 122. In one embodiment, the financial data 148 may include financial information such as the user's income, rent or mortgage payments, as well as a social security number or other credit identifying information.

The financial system 114 utilizes the financial data 148 and performs automated processing operations for finding credit terms associated with the vehicle. While not expressly illustrated in FIG. 3, the interface 110 may also transmit automobile information to the financial system 114 so that the financial system 114 processes the credit application based on the associated vehicle. For example, a newer model car may qualify for better financing terms over a late-model car, where the financing terms can include not only an interest rate, but also a term, e.g. 48 months, 60 months, etc.

The financial system 114 may interface with existing financial system operations to shop the vehicle credit application to multiple lenders for the return of a best interest rate and term. In one embodiment, the financial system 114 electronically communicates with one or more financial institutions and submits the credit application information to these institutions. The application information may include details about the individual, such as credit score, and information about the vehicle. The financial institutions can process this information make informed credit-worthy decisions about the financial terms they are willing to offer and submit those terms back to the financial system 114.

In other embodiment, the financial system 114 may seek to auction the financing such that various financial institutions can bid their financial terms using any suitable algorithms on the financial institution processing system. The financial system includes data storage for these operations using the financial data storage device 124. It is additionally noted that various details of the communication with the financial processing device 114 to the financial institutions have been omitted for clarity purposes only and it is recognized that these communications may be performed using known communication techniques.

In one embodiment, the financial data 148 may include a request for a particular term and a down payment amount and in another embodiment, these and other factors may be presented to the user as financing options. The financial system 114 submits terms to the interface 110, which therein provides the terms to the user 104. The interface 110 may, in one embodiment, reformat or otherwise manipulate the financial data, such as presenting the data in a more user friendly interface.

In the event the user 104 accepts the terms, the interface 110 receives an acceptance 152 from the user 104. This acceptance is then provided back to the financial system 114 for back-end processing to conduct further processing of the financial transaction and proceeding the online sales to completion. In one embodiment, if the user is presented with multiple financing offers, the acceptance 152 may indicate the selection of a particular offer. Typically, the offer includes associated factors of the loan term, down payment, interest rate and estimated monthly payments. In addition, the offer(s) include any additional information required under any applicable governing loan disclosure laws or guidelines.

In the embodiment of FIG. 3, after acceptance 152, the interface therein begins the settlement process 154. This settlement process is performed by the settlement processing device 116 in conjunction with data storage with the settlement database 126. These settlement operations include, but are not limited to, operations for the consummation of the online transaction. It is understood that physical verification can be required for aspects of the settlement, but the settlement processing device 116 performs all available electronic settlement operations to minimize in-person operations. Aspects of the settlement processing device are described in further detail below.

In this system of FIG. 3, when the settlement process is begun, or in another embodiment, when it is finished, the interface 110 receives a confirmation. Based on this confirmation, the interface 110 notifies the user that the vehicle is ready for pick-up 158 so that the user can therein schedule a time to pick-up the vehicle. In another embodiment, the user may have the car delivered, as described in further detail below. It is also during this pick-up or delivery that the user can perform the manual required operations, such as verifying his or her identity, verifying insurance if required, and satisfying any additional factors such as proof of residency or the physical signing of any documentation requiring actual signature, such as for example but limited to an odometer statement, if needed. In additional embodiments described below, other techniques may include the user using electronic signatures or other forms of electronic verification of signing and/or authorizing the vehicle sale/transfer transaction. Therefore, using the data flow steps of FIG. 3 in the OAS 102 of FIG. 2, the user 104 electronically completes an online automotive purchase. In another aspect of the settlement process, in one embodiment, the purchaser can select or otherwise indicate preferences regarding license plates for the vehicle, including transferring the user's license plates from an existing vehicle, applying for new plates, requesting a state-sponsored theme or specialty license plate, or if available, requesting a vanity license plate.

FIG. 4 illustrates a flowchart of the steps of one embodiment of a method for an online automotive purchase. The steps of the flowchart may be for a computerized method operating one or more processing devices in a unitary or distributed computing environment. For example, the methodology may be performed in a processing environment similar to the systems of FIGS. 1 and 2, but is not expressly restricted or limited to those disclosed processing environments.

In this methodology, a first step 180 is receiving a user input across a computer communication network for determining and verifying an identity of a user engaging in an online purchase of an automobile. This step may include logging into a user account and other related actions, including security and identity verification software encoded routines and operations.

A next step, step 182, is determining, using a first processing device, a plurality of characteristics of the user usable for the online purchase. These characteristics may be user-submitted characteristics, such as if the user enters the information into one or more questionnaires, moreover the information may be user-generated by tracking user activity or accessing other user-generated content, such as by way of example linking of user information with social media information.

A next step, step 184, is determining at least one automobile available for purchase by the user. This step may also be performed by the first processing device. This step may be performed in response to user search requests or any other available means, such as one or more automobile recommendation tools. The processing system presents the vehicles to the user, whereby the user can therein select a vehicle for purchase. It is recognized that in one embodiment, various processing steps described herein may be performed prior to log-in, and that the operations may be available to a user either not having an account with the online assisted sales system or a user who has not yet logged into that specific account. For example, step 184 may be performed using search criteria and not requiring the user to be logged into the system.

A next step, step 186, is receiving a plurality of financial information associated with the user for securing the automobile via the online purchase. This financial information may be similar to a credit application, employing encryption and security protocols to protect the information distributed in the networked environment. In one embodiment, the financial information is tied to the individual, such as based on the user's credit score or other financial factors. Based on this information, the user is then in a position to obtain financing for vehicles within the corresponding available credit range. While illustrated as step 186 herein, the obtaining of financial information may be performed prior to the car searching operations and not necessarily performed after a vehicle is selected. Although, in another embodiment, the financial information may be tied to the selected vehicle to pair financial information with the underlying asset securing the loan.

A next step, step 188, is determining, using a second processing device, financial terms for the online automotive purchase based on the financial information associated with the user. This second processing device may be a financial processing device or system having direct access to a plurality of financial institutions, wherein the institutions can make financial offers based on the financial data, including but not limited to the credit information of the user, any requested financing terms and the vehicle being financed.

A next step, step 190, is presenting the financial terms to the user across the computer communications network. This step may include requisite data encryption and security, as well as a user interface to present the information. In one embodiment, the interface may be a web-based portal accessible by the user via a web browser, the information being presented thereon. In another embodiment, the interface may be a standalone application such as an API or a mobile application accessible via a wired or wireless network. In one embodiment, this process may include one or more explicit user authorization request commands, such as a pop-up display or menu option that requires the user to expressly authorize the accessing of financial information. In another embodiment, authorization may be transmitted to the user via electronic communication means, including for example, but not limited to, electronic mail or text messaging including one or more links to the authorization requests.

It is recognized that in the embodiment wherein a user does not seek financing, steps 186, 188 and 190 may be omitted. Also, as described above, the financing may be performed at differing stages in the automotive purchase transaction, such as obtaining financing information prior to performing the searching operations to search based on a particular price range, by way of example.

A next step, step 192, includes that upon user acceptance of the financial terms, electronically performing a plurality of settlement transactions for fulfillment of the online automotive purchase transaction, as described in further detail below.

In this embodiment, a final step, step 194, is notifying the user of the availability of delivery of the automobile. This delivery may be informing the user to come to a designated location, where the vehicle will be waiting, such as an auto dealership. This notification for in-person collection of the vehicle may include a list of documents for the user to bring to finalize the transaction. This notification may cross-reference and access inventory and service availability resources to insure that the automobile is properly serviced, detailed and ready for delivery. The notification may also account for additional online sales transactions to insure there is no overlap on delivery date and time to insure the user is provided individualized treatment and minimize wait-time for vehicle delivery.

As indicated above, delivery of the vehicle may also be based on the physical delivery of the vehicle to the buyer. For example, the car may be delivered to the buyer's home or work, such as a salesman or other agent physically driving and dropping the vehicle off. In another example, a vehicle delivery service may transport and leave the vehicle. Delivery means may utilize any suitable means, wherein the delivery in this embodiment provides for the vehicle to delivered to the user and not having the user visit a designated retail or other location.

With an embodiment providing delivery of the vehicle, additional embodiments are provided for the settlement process. In one embodiment, the user may electronically receive documents, printout, sign and physically return. In another embodiment, the user may sign and submit electronic copies or faxes of the documents. In another embodiment, the user may utilize an electronic signature to sign documents, eliminating the need for physical copies. Additional embodiments as recognized by one skilled in the art are envisioned herein such that the corresponding paperwork for the settlement transaction is properly executed.

In another embodiment, prior to delivery of the vehicle, and maybe within the settlement process, the user may select one or more additional features to supplement the automotive purchase. As described in greater detail below and samples illustrated in the screenshots, additional add-ons may be included in the vehicle transaction, such as selling vehicle add-ons, aftermarket products, vehicle care protection packages, car insurance, gap insurance, among other supplemental options.

Therefore, in this embodiment, the methodology provides for the online automotive purchase. The methodology provides electronic processing operations allowing for the performance of automotive sale actions previously requiring in-person employees to perform these actions, but also requiring a significant time investment on the part of the customer when purchasing the vehicles. The back-end processing offers secure and streamlined operations for vehicle searching, selection, financing and settlement.

Additional embodiments of the method and system include verifying the user's identity for subsequent delivery of the vehicle and completion of the automotive purchase. This verification can be through electronic means, such as digital signatures, a biometric device, e.g. a fingerprint scanner, or any other available electronic means. The verification can also be done in-person, such as the delivery and inspection of a driver's license or other form of government issued identification.

Another embodiment of the method and system can include additional utilization of the user information in the vehicle searching and database accessing operations. One step may include determining the location of the user and narrowing or limiting the search based on the user's location. This location may be determined by user-entered information or could also be based on noting an internet access point and corresponding geographic region based on that point. In one embodiment, the database searching can be limited to a particular region based on a designated mileage, which may include the ability for transfer between vehicles between locations or can limit the OAS to vehicles available in a designated dealership or region of dealerships.

Vehicle transfer between locations may be performed where the automobile is located at a predetermined distance from the buyer. The location having the vehicle may be a different dealership or could be any other suitable type of location, such as for example a storage facility. The vehicle transfer may be for a fee. In one embodiment, this vehicle transfer fee is payable by the user, wherein in another embodiment, this fee may be incorporated into a final purchase price for a subsequently purchased vehicle. Another embodiment allows for complimentary vehicle transfer, which may be based on any number of suitable factors, such as transfer distance, vehicle type, vehicle cost, etc. Additionally, in one embodiment, the OAS may allow a user to expand a search parameter based on the user agreeing to accept delivery at a particular location.

In one embodiment, the method may further expand upon the tracking 138 of the interaction 136 between the user 104 and the inventory database 122 via the interface 110. The tracking 138 may include monitoring the activities of the user performing the automotive searching operations and associating these activities with the user in a user profile database as one of the plurality of user characteristics. Therein, in this embodiment of the method, the OAS determines one or more automobiles available for purchase by taking into account the searching operation activities stored in the user profile database. The user is presented with a recommendation or the search is augmented based on the user's previous searching activities. This methodology may include algorithmic data mining and/or matching operations, such as noting similarities between various vehicles.

In one embodiment, the settlement operations include calculating taxes and fees applicable to the automotive transaction. The taxes may include referencing state-specific guidelines for the automotive sale, including applicable state and/or county taxes, as well as any applicable fees. The fees may be government mandated fees or can be the seller's fees.

Settlement operations may additionally include steps for transferring the vehicle title to the buyer. The title of the vehicle, while being offered for sale, may be held in the name of an individual, in a business or in limbo status while awaiting sale. Settlement processes may include preparing paperwork for title transfer, including, for example, but not limited to, an odometer statement, lien documentation, loan paperwork, etc. In one embodiment, the paperwork may be electronically transmitted to the buyer, for the buyer to sign using either an actual physical signature or an electronic signature. With an electronic signature, the documents may be electronically returned to the seller. With a physical signature, the documents may be transmitted back to the seller, such as via fax, scan and email, courier or in-person delivery, etc. The settlement process provides for the generation of the paperwork for finalizing the automotive transaction and the acquisition of the buyer's signature where necessary.

The settlement operations additionally include the preparation of the settlement transaction paperwork for the user to sign in-person. In another embodiment, the paperwork may be electronic and utilize an electronic signature to complete the transaction electronically. This includes generating reports or associated paperwork, such as loan documents and other paperwork that require a physical signature as well as personal verification. In one embodiment, some or all of these settlement documents may be made available to the user prior to settlement, such as being sent via fax or email or being available when the user is logged into their account on the user account system 112.

Before, during or after the acceptance 152, one embodiment of the present method and system accounts for the inventory management of the vehicle in the inventory database 122. In one embodiment, the inventory database 122 is accessible by both online and in-store personnel. The OAS can operate in conjunction with the retail in-store operations and one embodiment includes steps to avoid the errant offering for sale in the retail location a vehicle that has been accepted for purchase via the OAS.

The OAS may define a transaction step as a significant engagement step. At this step, the OAS seeks to remove the vehicle from availability for sale by the retail location, as well as other OAS users. The significant engagement step can be any number of steps in the transaction process, including but not limited to when the user submits a request to purchase a vehicle, or when the user begins the settlement process. The method and system includes receiving a confirmation of a significant engagement by the user for the online automotive purchase and then updating the vehicle inventory database 122 to indicate the vehicle as no longer available for purchase. Differing embodiments may include merely removing the vehicle from the available viewable options in the database or leaving it as viewable but noting that it has a sale pending.

In one embodiment, the significant engagement may include transmitting a message to the user and receiving confirmation of receipt and acknowledgement of the electronic message. In one embodiment, this is via the user interface, and communication with the user to the back-end car processing system. As noted above, these messages may be during any number of possible steps in the method and system wherein the user, via engagement with the interface, expresses and confirms an interest to purchase the automobile.

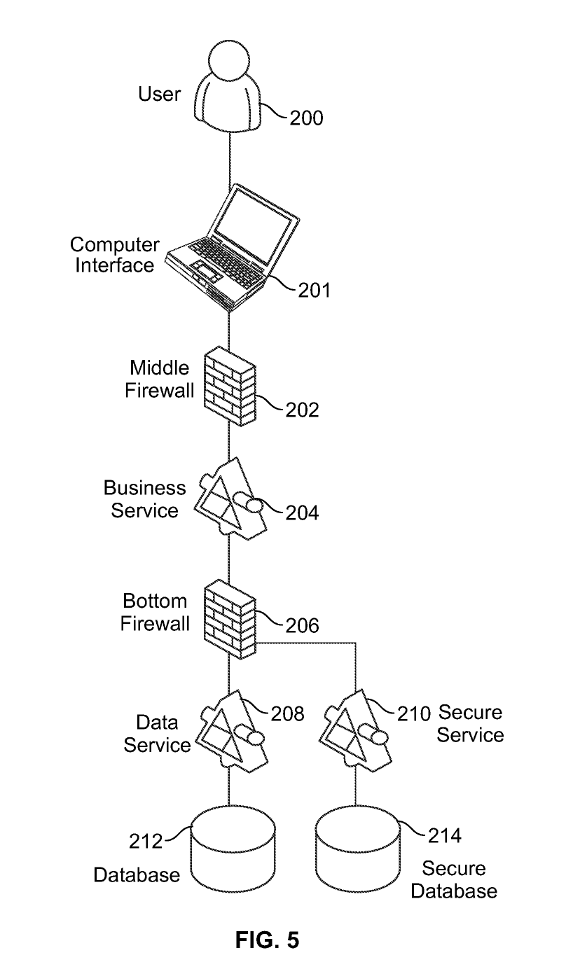

FIG. 5 illustrates a generalized architecture diagram of one embodiment of the OAS. The architecture is accessible by a user 200 accessing a user interface 201 via a middle firewall 202 to access the business service engine 204. The middle firewall 202 may be any suitable firewall providing associated security and data flow management operations. The business service 204 represents the associated processing architecture for the front of the OAS, including the data interface for sequencing and managing data flow from the back-end processing components to the user.

Behind the business service 204 is an optional bottom firewall 206, which may be similar to the middle firewall 202 or may include additional layers of security and provide a higher lever of restricted access to the data behind the optional bottom firewall 206. Behind this optional firewall 206 includes the data service engine 208 and a secure service engine 210. The data service engine accesses the database 212 and the secure service engine accesses the secure database 214.

The engines 204, 208 and 210 use any number of processing devices to perform processing operations for the OAS as described in detail above. The secure service engine 210 includes additional encryption and data security features for managing and handling secure data, such as user financial data by way of example.

FIG. 5 illustrates a service oriented architecture that includes a pure service layer. The pure service layer, in this embodiment, has no access from the user interface to database, but rather has a data flow from the user interface to the business service to the database access service to data storage. There are, in this embodiment, no open ports to any of the databases in the firewall for additional security having the data storage disposed at the bottom layer. The architecture, in one embodiment, also provides for load balancing with synchronous servicing for users/clients, but is also available to provide clustered services using asynchronous responses to the users/clients.

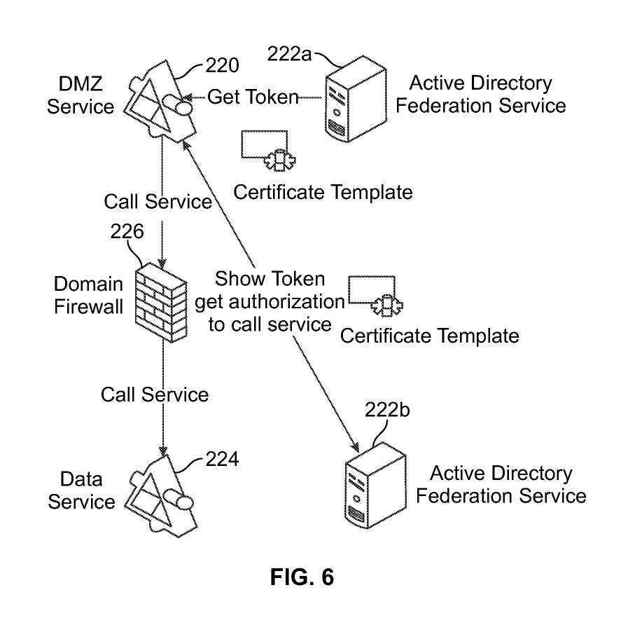

FIG. 6 illustrates one embodiment an active directory within the OAS. The active directory includes a demilitarized zone (DMZ) service 220 for acting as a secure gateway from the OAS to the Internet. The DMZ service 220 operating on one or more processing devices, receives security tokens from a server 222a. The DMZ service 220 interfaces with a data service 224 via a domain firewall 226. This architecture provides a further level of security protecting data in the OAS.

The DMZ service 220 further predicates the call service to the data service 224 via the firewall 226 by showing the token from the server 222a to another active directory federation service 222b. It is through this communication, the DMZ service 220 receives authorization for the call service through the firewall 226 to the data service 224. In one embodiment, this active directory includes clustering of application servers, as well as authorizing service calls from middle to bottom.

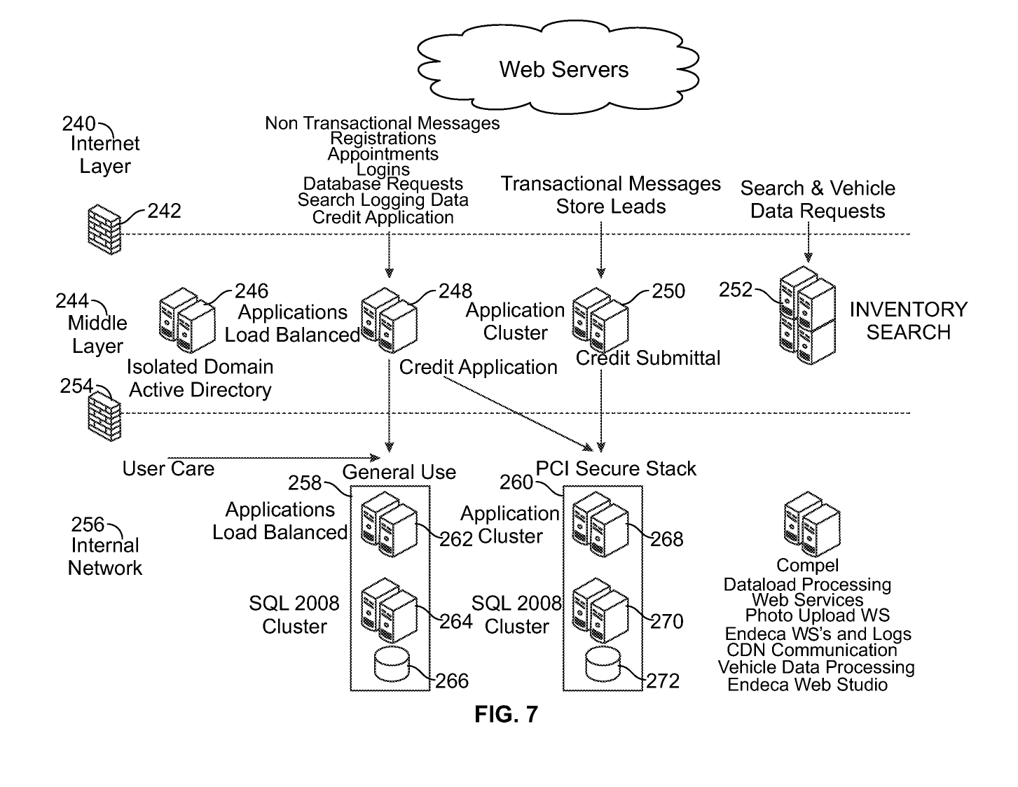

FIG. 7 illustrates a graphical representation of one embodiment of a layering of the computing architecture for the OAS. The Internet layer 240 illustrates incoming web traffic via a plurality of web servers using known incoming data traffic transmission techniques.

A firewall 242 is disposed between the internet layer 240 and the middle layer 244. The middle layer 244 includes an isolated domain active directory 246, load balancing for credit or financial application processing devices 248, application cluster processing devices 250 and processing devices 252 for managing search and vehicle data requests.

Below a second firewall 254 is the internal network 256. This network includes a general processing system 258 and a secure processing system 260. The general processing system 258 includes load balanced application processing devices 262 and data accessing components with query processing devices 264 and associated storage devices 266. The similar architecture is also found on the secure system 260 including processing devices 268, query processing devices 270 and secure storage 272.

In one embodiment, the internal network includes further processing devices 274 for further data load processing outside of the direct application load balance stack 248 through processing stacks 258 and 260. It is noted the corresponding architecture of FIG. 5 mirroring the layering of the architecture of FIG. 7, with FIG. 7 illustrating additional components and further expansion on the services of FIG. 5.

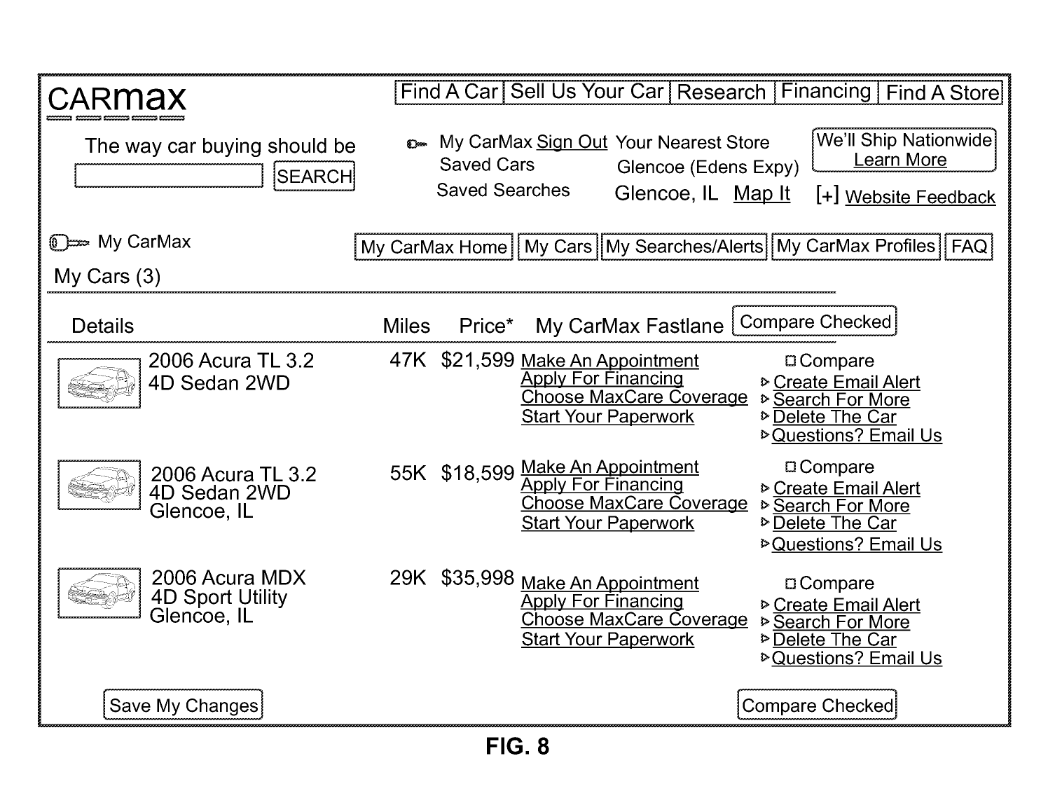

For further illustration of one embodiment of the OAS, FIGS. 8-12 illustrate sample screenshots as visible by a user. These screenshots represent exemplary displays provided to the user through the networked connection for the middle layer 244 of FIG. 7 including data available from the internal network 256.

FIG. 8 illustrates a sample car inventory search result. In this example, the user may be signed in to a registered account and have performed a search for Acura® automobiles available within a designated region. This screenshot shows three sample available vehicles with the corresponding price, mileage and active links for additional information. Also visible in the screenshot are active links for selecting the vehicle for purchase. The active links are just right of the price, including links for making an appointment to see the vehicle, apply for credit, choose warranty coverage and begin online paperwork for settlement.

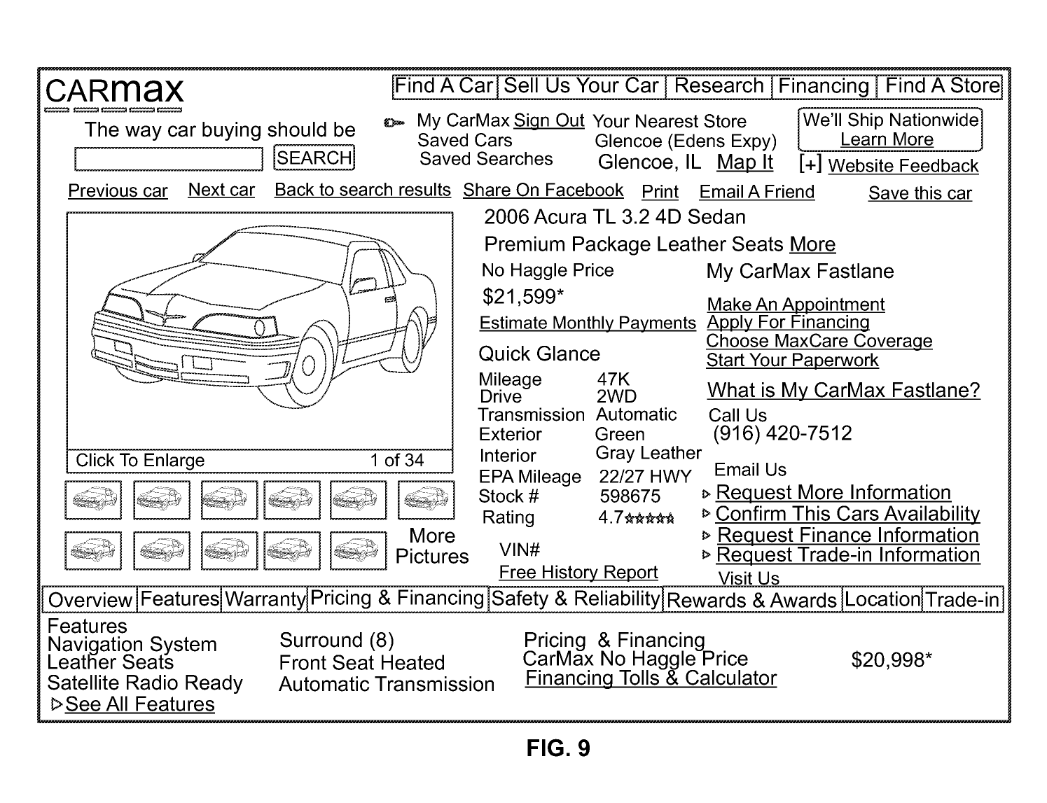

FIG. 9 illustrates a sample screenshot upon user selection of the first display result. FIG. 9 illustrates multiple pictures of the vehicle, as well as the display of all available vehicle information. Again, on the right portion of the screenshot are the active links for the vehicle purchase.

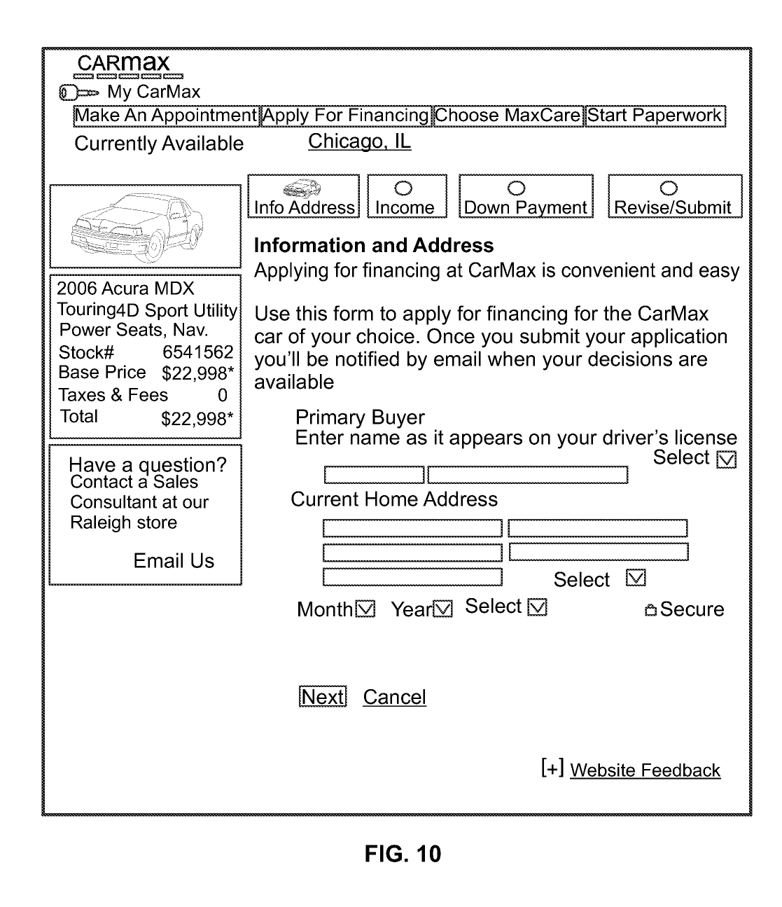

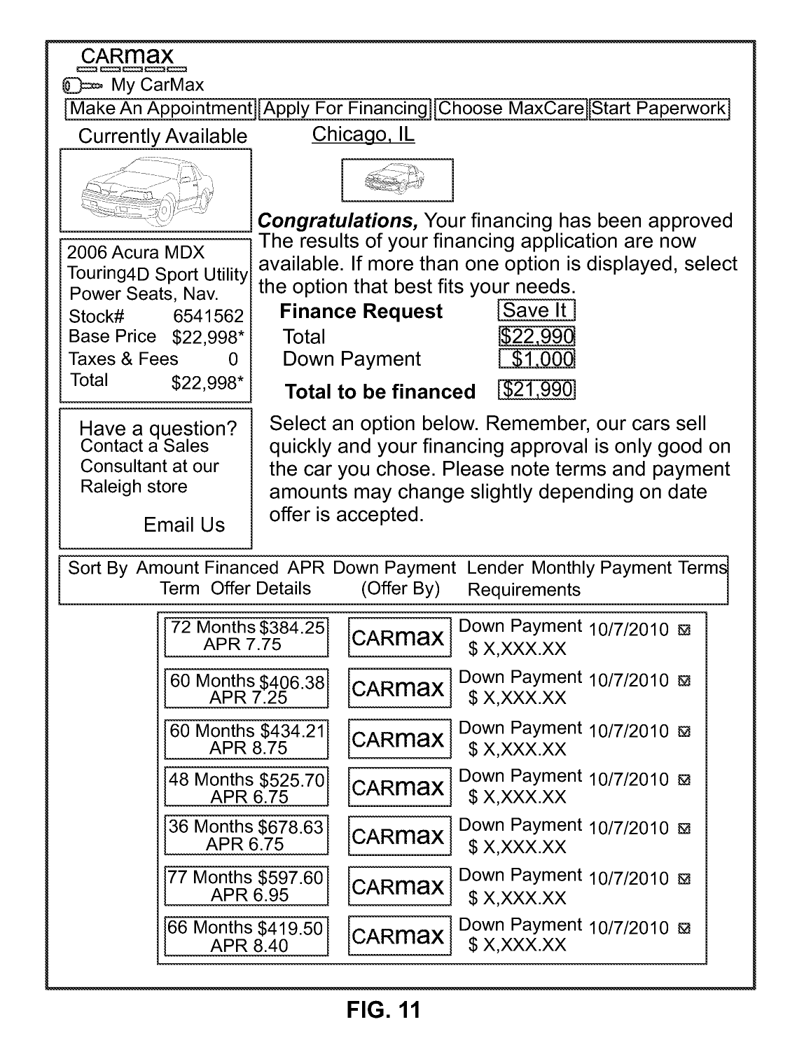

Upon user selection of the vehicle for purchase, the user can submit financial information for requesting financing options. FIG. 10 illustrates a sample screenshot of a financial application. Upon user input and submission of financial information, FIG. 11 illustrates a sample screenshot of a resultant display. In the display of FIG. 11, the user is presented with multiple financing offers for varying terms, where the screenshot of FIG. 11 represents that user has a sufficient credit history and is presented with the following options to finance the purchase of the selected vehicle.

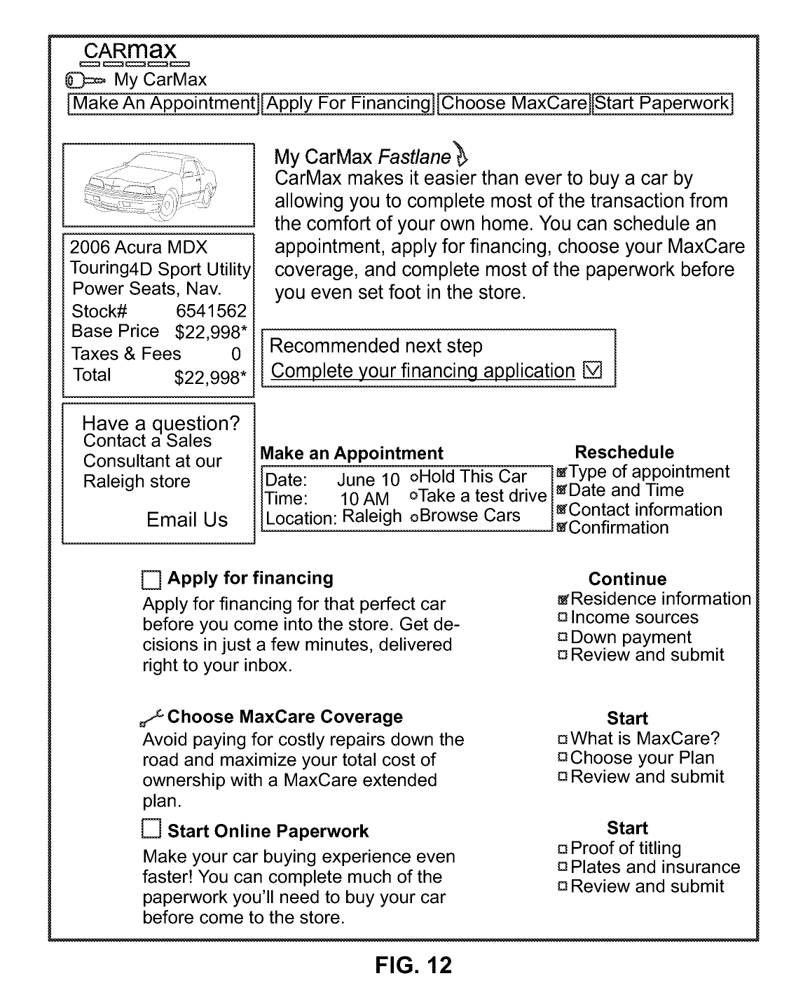

FIG. 12 illustrates a further display of the online settlement transactions for the OAS. In this screenshot, the user is presented with the steps for completing the online transaction and the interface shows a status indicator. In the illustrates screenshot, the user has made an appointment and is in the process of completing the financial process. This user continues through the coverage selection and starting the online settlement process. For example, the user can select car care coverage options, such as reviewing and selecting an available coverage choice. Other options can include insurance, such as car insurance or financing insurance, e.g. gap insurance.

The online settlement can include tracking indicators showing where the user is in the transaction, such as proof of titling, plates and insurance, etc. In addition, not expressly shown, the user can select additional add-ons, such as adding features on to the car, such as aftermarket features. By way of example, an aftermarket feature can be the installation of a satellite radio or an MP3 adaptor.

Therein, the present method and system provide for an online assisted sales system for the purchase of an automobile. The method and system combines previously disjointed human operations into a cohesive electronic transaction, as well incorporated processing architecture in a secure environment for managing all aspects of the transaction. The OAS merges the various automotive purchasing operations into a single transaction system with multi-layered secure architecture for streamlining the process, as well as providing a high degree of security and data integrity.

FIGS. 1 through 12 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A computerized method for an online automotive purchase, the method comprising:
electronically receiving a user input across a computer communication network for determining and verifying an identity of a user engaging in an online purchase of an automobile;
electronically determining, using a first processing device, a plurality of characteristics of the user usable for the online purchase;
in response to at least one user selection command, electronically determining, using the first processing device, at least one automobile available for purchase by the user;
electronically receiving a plurality of financial information associated with the user for securing the automobile via the online purchase;
electronically determining, using a second processing device, financial terms for the online automotive purchase based on the financial information associated with the user;
presenting the financial terms to the user across the computer communication network;
upon user acceptance of the financial terms, electronically performing a plurality of settlement transactions for fulfillment of the online automotive transaction; and
electronically notifying the user regarding delivery of the automobile.

2. The method of claim 1 further comprising:
verifying the user's identity for subsequent delivery of the vehicle and completion of the automotive purchase.

3. The method of claim 1 further comprising:
determining a location of the user such that the determining of the at least one automobile available for purchase is within a predefined geographic region.

4. The method of claim 1 further comprising:
monitoring activities of the user for automotive searching operations;
associating these activities with the user in a user profile database as one of the plurality of user characteristics; and
determining the at least one automobile available for purchase by taking into account the searching operation activities stored in the user profile database.

5. The method of claim 1, wherein the step of receiving a plurality of financial information further comprises:
engaging security protocols for electronic communications from the user to the second processing device across the networked connection;
receiving private information about the user allowing for the determination of a credit applicability determination; and
receiving authorization from the user for utilizing the private information.

6. The method of claim 1, wherein the performing of the plurality of settlement transactions includes:
calculating taxes and fees applicable to the automotive transaction;
initiating a vehicle title transfer operation; and
preparing paperwork for in-person verification and signature by the user.

7. The method of claim 1 further comprising:
determining the vehicle available for purchase through conducting an electronic search of a vehicle inventory database.

8. The method of claim 7, wherein the vehicle inventory database is additionally accessible by in-person automotive purchase locations, the method further comprising:
receiving a confirmation of a significant engagement by the user for the online automotive purchase; and
updating the vehicle inventory database to indicate the automobile as unavailable for purchase by a second party.

9. The method of claim 8, wherein the receiving the confirmation of the significant engagement includes:
transmitting an electronic message to the user; and
receiving confirmation of receipt and acknowledgement of the electronic message by the user.

10. The method of claim 1 further comprising:
presenting to the user a plurality of automobile available for purchase; and
receiving a user vehicle selection, selecting the automobile for purchase from the plurality of available automobiles.

11. The method of claim 10, wherein the plurality of automobiles presented to the user is determined based on at least one financial characteristics of the user.

12. The method of claim 10, wherein the plurality of automobiles presented to the user is determined by at least one vehicle criteria.

13. A system for performing an online automotive purchase; the system comprising:
a computer readable medium having executable instructions stored thereon; and
at least one processing device, in response to the executable instructions, operative to:
receive a user input across a computer communication network for determining and verifying an identity of a user engaging in an online purchase of an automobile;
determine a plurality of characteristics of the user usable for the online purchase;
in response to at least one user selection command, determine, using the first processing device, at least one automobile available for purchase by the user;
receive a plurality of financial information associated with the user for securing the automobile via the online purchase;
determine financial terms for the online automotive purchase based on the financial information associated with the user;
present the financial terms to the user across the computer communication network;
upon user acceptance of the financial terms, electronically perform a plurality of settlement transactions for fulfillment of the online automotive transaction; and
notify the user regarding delivery of the automobile.

14. The system of claim 13, the processing device, in response to further executable instructions, further operative to:
determine a location of the user such that the determining of the at least one automobile available for purchase is within a predefined geographic region.

15. The system of claim 13, the processing device, in response to further executable instructions, further operative to:
monitor activities of the user for automotive searching operations;
associate these activities with the user in a user profile database as one of the plurality of user characteristics; and
determine the at least one automobile available for purchase by taking into account the searching operation activities stored in the user profile database.

16. The system of claim 13, the processing device, in response to further executable instructions, further operative to:
engage security protocols for electronic communications from the user to the second processing device across the networked connection;
receive private information about the user allowing for the determination of a credit applicability determination; and
receive authorization from the user for utilizing the private information.

17. The system of claim 13, wherein the performing of the plurality of settlement transactions includes:
calculating taxes and fees applicable to the automotive transaction;
initiating a vehicle title transfer operation; and
preparing paperwork for in-person verification and signature by the user.

18. The system of claim 13, the processing device, in response to further executable instructions, further operative to:
determine the vehicle available for purchase through conducting an electronic search of a vehicle inventory database.

19. The system of claim 18, wherein the vehicle inventory database is additionally accessible by in-person automotive purchase locations, the method further comprising:
receiving a confirmation of a significant engagement by the user for the online automotive purchase; and
updating the vehicle inventory database to indicate the automobile as unavailable for purchase by a second party, wherein the receiving the confirmation of the significant engagement includes:
transmitting an electronic message to the user; and
receiving confirmation of receipt and acknowledgement of the electronic message by the user.

20. The system of claim 13, the processing device, in response to further executable instructions, further operative to:
present to the user a plurality of automobile available for purchase; and
receive a user vehicle selection, selecting the automobile for purchase from the plurality of available automobiles.

21. The system of claim 10, wherein the plurality of automobiles presented to the user is determined based on at least one financial characteristics of the user.

22. The system of claim 10, wherein the plurality of automobiles presented to the user is determined by at least one vehicle criteria.

23. Computer readable media comprising program code that when executed by a programmable processor causes execution of a method for an online automotive purchase, the method comprising:
computer program code for electronically receiving a user input across a computer communication network for determining and verifying an identity of a user engaging in an online purchase of an automobile;
computer program code for electronically determining, using a first processing device, a plurality of characteristics of the user usable for the online purchase;
computer program code for, in response to at least one user selection command, electronically determining, using the first processing device, at least one automobile available for purchase by the user;
computer program code for electronically receiving a plurality of financial information associated with the user for securing the automobile via the online purchase;
computer program code for electronically determining, using a second processing device, financial terms for the online automotive purchase based on the financial information associated with the user;
computer program code for presenting the financial terms to the user across the computer communication network;
computer program code for upon user acceptance of the financial terms, electronically performing a plurality of settlement transactions for fulfillment of the online automotive transaction; and
computer program code for electronically notifying the user regarding delivery of the automobile.
